(19) United States
(12) Patent Application Publication
(10) Pub. No.: US 2019/0314247 A1
(43) Pub. Date: Oct. 17, 2019

(54) INFANT SAFETY CAP

(71) Applicant: Medela Holding AG, Baar (CH)

(72) Inventors: Mike Fleury, Brea, CA (US); Deanna Gilbert, Brea, CA (US); Kathryn Mizuchi, Brea, CA (US)

(21) Appl. No.: 16/314,626

(22) PCT Filed: Jul. 12, 2017
(86) PCT No.: PCT/US17/41760

§ 371 Date: Dec. 31, 2018

Related U.S. Application Data
(63) Continuation of application No. 29/606,599, filed on Jun. 6, 2017, now Pat. No. D842999.
(60) Provisional application No. 62/361,811, filed on Jul. 13, 2016.

(51) Int. Cl. A61J 7/00; A61J 1/14

(52) U.S. Cl. CPC A61J 7/0053; A61J 17/00; A61J 1/1412

(57) ABSTRACT

An infant safety cap that provides a clear view of the region around the patients mouth during oral administration of fluid, and meets childproof guidelines set by the Consumer Product Safety Commission in 16 CFR § 1501 is set forth. In addition, an ENFit syringe safety cap system incorporating the infant safety cap, constructed in accordance with the principles herein, enables safe and effective fluid delivery, while providing a clear view section around a small outer diameter fluid delivery channel of the cap, which is particular useful for verifying delivery of the fluid. The cap can be selectively sealed to provide a tamper-proof dosage delivery, and to verify the contents of the attached container.

### CROSS-REFERENCE TO RELATED APPLICATIONS

The present application claims priority to PCT International Application No. PCT/US2017/041760 filed on Jul. 12, 2017, which is related to U.S. Design Pat. application No. 29/606,599 filed Jun. 6, 2017 and claims priority to U.S. Provisional Patent Application No. 62/361,811 filed Jul. 13, 2016, the entirety of the disclosures of which are expressly incorporated herein by reference.

### STATEMENT RE: FEDERALLY SPONSORED RESEARCH/DEVELOPMENT

None.

### FIELD OF THE DISCLOSURE

The present disclosure relates generally to an infant safety cap. The infant safety cap selectively and removably connects, either directly or indirectly, to an ENFit syringe, pharmaceutical bottle, container, or the like.

### BACKGROUND

Proper nutrition is critical at all stages of life for maintaining good health. However, infants, and particularly neonates, may have poor voluntary intake or lack the ability to consume enough food on their own. Therefore, it is common for nutritional foods, either alone or in combination with selected medications, to be prepared as fluid that is suitable for delivery to the infant. Fluid delivery to infants is typically carried out either by direct delivery to the gastrointestinal tract of the patient, which is generally referred to as enteral delivery, or by direct oral administration. In either case, a syringe or other delivery device can be filled or loaded with the desired fluid in a pharmacy, on the nursing floor, or in any other suitable location.

In certain instances, fluid may be delivered to the patient using direct oral administration by placing a syringe, or syringe connector, within the patient's mouth and then dispensing the fluid. Fluid can also be delivered to a feeding tube via a syringe. The syringe may include complimentary ENFit fittings or connectors to effectuate fluid communication with feeding tube connectors. Oral dispenser caps, adapted for connecting to an ENFit syringe, can be connected to the syringe, as needed, if oral administration is desired.

Oral dispenser caps can provide fluid delivery while minimizing potential choking hazards as required by the Consumer Product Safety Commission. However, known oral dispenser caps are generally large and bulky, like pacifiers. Other known oral dispenser caps do not remove choking hazards or allow for a clear view of the area around the patient's mouth where breast milk or other fluid will be orally administered to the patient while minimizing the diameter of the fluid delivery channel of the dispensing cap.

### BRIEF SUMMARY

In one embodiment, an infant safety cap constructed in accordance with the principles herein includes a cap receiving end having a receiving channel. The outer edge of the cap forms a choke-prevention guard for the cap. The safety cap is configured to provide a clear view section around a small outer diameter fluid delivery channel. The outer edge of the cap can be formed to directly or indirectly connect to the fluid delivery channel. The receiving channel can be constructed to selectively and removably connect to at least one of an ENFit syringe, a pharmaceutical bottle, and a container.

In another embodiment an ENFit syringe safety cap system can include an ENFit syringe, and an infant safety cap configured to selectively connect to the ENFit syringe.

In yet another embodiment, the infant safety cap can include a removable cap seal. The removable cap seal can be formed to be connectable to an infant safety cap. To this end, the removable cap seal can form a tamper-resistant seal, the seal connecting an outlet of the small outer diameter fluid delivery channel to at least one of the outer edge, the ENFit syringe, the pharmaceutical bottle, and the container, either directly or indirectly.

Various advantages of the present disclosure are specifically described below in reference to the exemplary embodiments, or conceptually embodied therein, and are provided to merely illustrate examples of the general concepts discussed throughout the disclosure. Numerous changes and modifications can be made as known to those of skill in the art without departing from the general principles set forth herein. In addition, all patents and publications referenced are incorporated herein by reference in the entirety.

### BRIEF DESCRIPTION OF THE DRAWINGS

These and other features and advantages of the various exemplary embodiments disclosed herein will be better understood with respect to the following description and drawings, in which:

FIG. 1 is a perspective view of a first exemplary embodiment constructed in accordance with the principles herein;

FIG. 2 is a is a perspective view of a second exemplary embodiment constructed in accordance with the principles herein;

FIG. 3 is a is a perspective view of a third exemplary embodiment constructed in accordance with the principles herein;

FIG. 4 is a top view of the exemplary embodiment of FIG. 1;

FIG. 5 is a top view of the exemplary embodiment of FIG. 2;

FIG. 6 is a top view of the exemplary embodiment of FIG. 3;

FIG. 7 is a side view of the exemplary embodiment of FIG. 1;

FIG. 8 is a side view of the exemplary embodiment of FIG. 2;

FIG. 9 is a side view of the exemplary embodiment of FIG. 3;

FIG. 10 is a bottom view of the exemplary embodiment of FIG. 1;

FIG. 11 is a bottom view of the exemplary embodiment of FIG. 2;

FIG. 12 is a bottom view of the exemplary embodiment of FIG. 3;

FIG. 13 is an exemplary embodiment of a system constructed in accordance with the principles herein;

FIG. 14 is a perspective view of the exemplary embodiment of FIGS. 1, incorporating an example of a removable seal 60 that can serve to verify delivery of the contents of a syringe;

FIG. 15 is a perspective view of the exemplary embodiment of FIGS. 2, incorporating an example of a removable seal 60′ that can serve to verify delivery of the contents of a syringe; and

FIG. 16 is a perspective view of the exemplary embodiment of FIGS. 3, incorporating an example of a removable seal 60″ that can serve to verify delivery of the contents of a syringe. Common reference numerals are used throughout the drawings and the detailed description to indicate the same elements.

### DETAILED DESCRIPTION

The detailed description set forth below in connection with the appended drawings is intended as a description of certain exemplary embodiments of various system components constructed in accordance with the principles herein, including an infant safety cap, an enteral delivery system, and a removable cap seal. These examples are not intended to represent the only embodiments or forms that may be developed or utilized according to these principles. It is further understood that the use of relational terms such as first and second, and the like are used solely to distinguish one entity from another without necessarily requiring or implying any actual such relationship or order between such entities.

Certain aspects of some embodiments constructed in accordance with the principles herein are directed toward an infant safety cap configured to connect to an enteral delivery system, wherein ENFit connectors are employed to connect components of the system. The use of ENFit connectors throughout the process of administering the drug or nutrients to the patient, i.e., from the transition of contents from the medicine bottle to the syringe, and then subsequently from the syringe to the patient, helps prevent misconnection with tubing connections associated with tubing serving other functionalities.

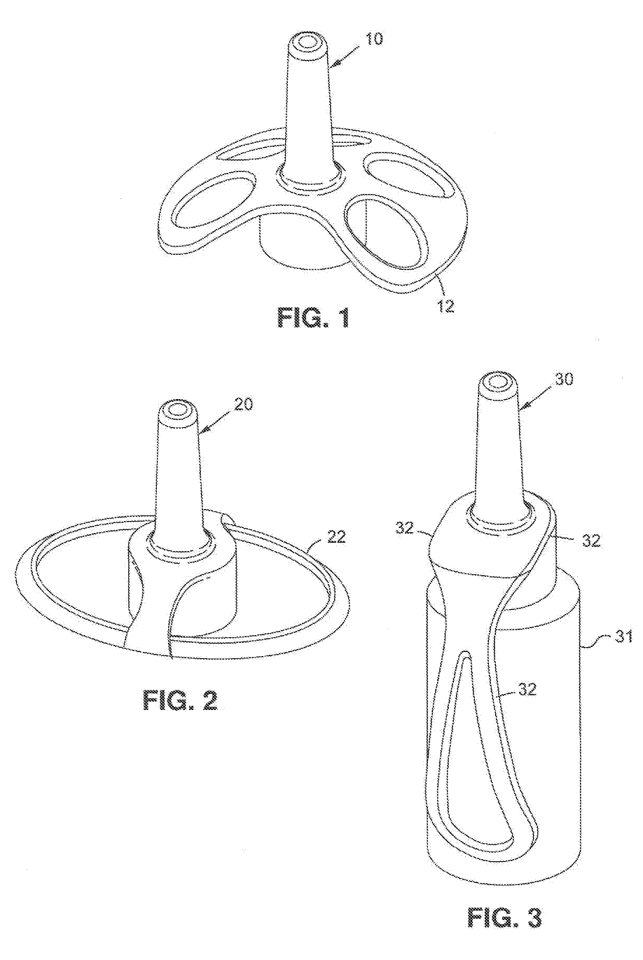

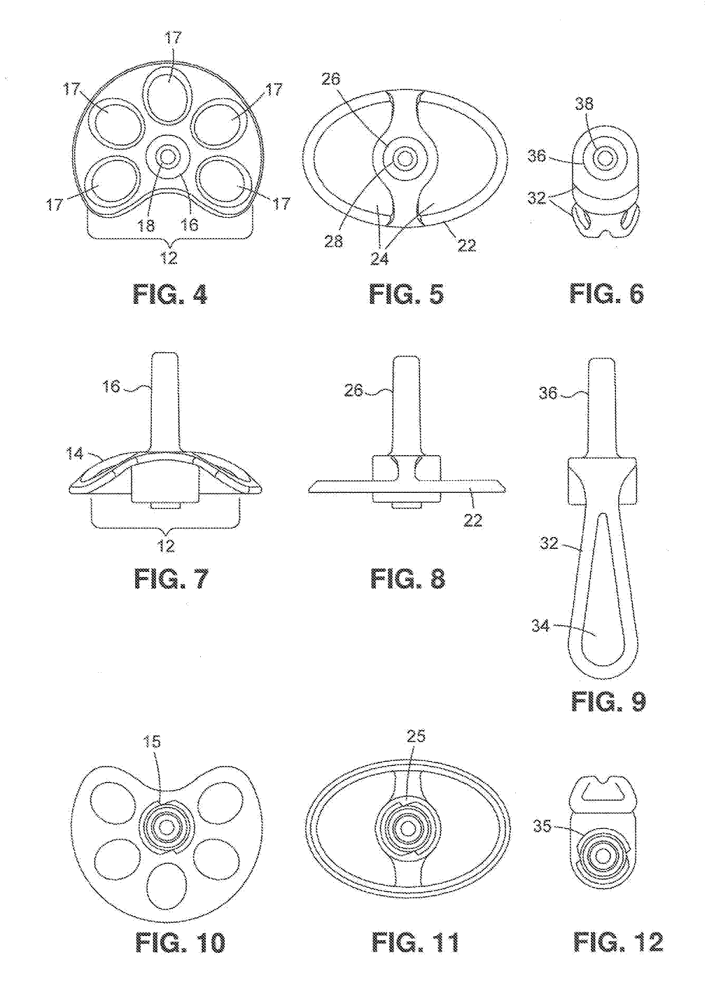

As will be described in more detail below, several embodiments are contemplated in accordance with the principles herein. For example, a first exemplary embodiment of the system shown generally at 10 is set forth in FIGS. 1, 4, 7, 10, and 14. A second exemplary embodiment of the system shown generally at 20 is set forth in FIGS. 2, 5, 8, 11, and 15. A third exemplary embodiment of the system shown generally at 30 is set forth in FIGS. 3, 6, 9, 12, 13 and 16.

It is understood that the systems described herein may be used to deliver a wide range of fluid contents to an infant, including medicine, food, combinations thereof, or other nutritional fluids. Such contents will be collectively referred to herein as “fluid” for purposes of simplicity.

An exemplary embodiment of an infant safety cap constructed in accordance with the principles herein is shown generally at 10 in FIG. 1. The safety cap 10 includes an outer edge 12 shaped to prevent choking during operation of the device, clear view sections 14 formed by selecting any suitable outer edge configuration, a receiving end 15 having structure to provide a leak proof connection to a container having fluid therein, and a small outer fluid delivery channel 16 minimize the outer diameter for the fluid outlet, all of which are shown in at least one of FIGS. 1, 4, 7, and 10. The small outer diameter fluid delivery channel does not require sucking action by an infant or patient.

Another exemplary embodiment of an infant safety cap constructed in accordance with the principles herein is shown generally at 20 in FIG. 2. The safety cap 20 includes an outer edge 22 shaped to prevent choking during operation of the device, clear view sections 24 formed by selecting any suitable outer edge configuration, a receiving end 25 having structure to provide a leak proof connection to a container having fluid therein, and a small outer fluid delivery channel 26 formed to minimize the outer diameter for the fluid outlet, all of which are shown in at least one of FIGS. 2, 5, 8, and 11.

Yet another exemplary embodiment of an infant safety cap constructed in accordance with the principles herein is shown generally at 30 in FIG. 3. The safety cap 30 includes an outer edge 32 shaped to prevent choking during operation of the device, clear view section 34 formed within the outer edge, and additional viewing area formed by selecting any suitable outer edge configuration. Here the outer edge 32 is minimized so that a clear view is also provided surrounding the outer edge 32. The safety cap 30 also includes a receiving end 35 having structure to provide a leak proof connection to a container having fluid therein, and a small outer fluid delivery channel 36 formed to minimize the outer diameter for the fluid outlet, all of which are shown in at least one of FIGS. 3, 6, 9, and 12. Any suitable container 31, here illustrated as a generally cylindrical container, can be selectively connected to the safety cap 30.

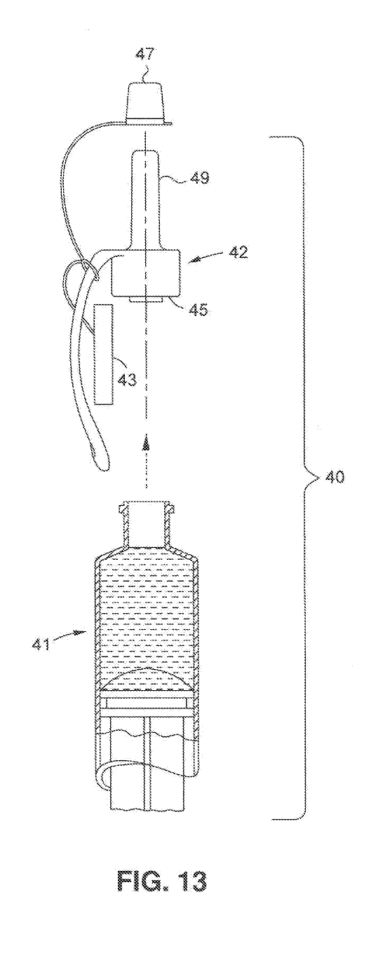

An ENFit syringe safety cap system, shown at 40 in FIG. 13, can include a suitable ENFit fluid container, such as an ENFit syringe 41, and an infant safety cap 42 configured to selectively connect to the ENFit syringe 41. The safety cap 42 can be configured to connect to the syringe 41 directly, via a receiving end 45, or via an adapter (not shown). A tamper resistant seal of any suitable configuration and material can be attached to the syringe 41 once the syringe 41 is connected to the cap 42. A tamper resistant seal 47 of any suitable configuration and material can be connected to a small outer diameter fluid delivery channel 49 of the cap 42. Once assembled, the frangible, tamper resistant members 43, 47 can be easily broken and/or removed to deliver the fluid in the syringe 41 through the cap 42 to a patient, while also providing a device function that enables the caregiver to verify the contents of the container as received, after transport to the patient.

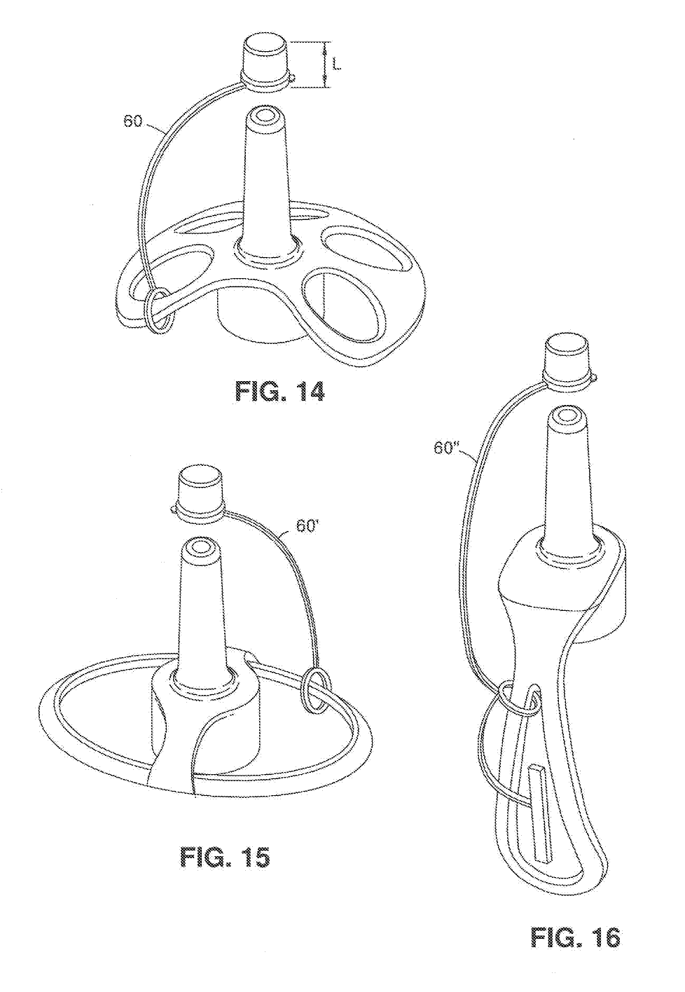

As illustrated in FIGS. 14, 15 and 16 any configuration of an infant safety cap constructed in accordance with the principles herein can include tamper-resistant members or seals 60, 60′, 60″ that can be of any suitable shape and size, and can connect to one or both of a container and the safety cap.

Variations of the specific device configurations shown and described herein that provide a choke prevention and clear view delivery for an infant safety cap having a minimal outer diameter fluid delivery channel are within the scope of the principles of the present disclosure, and are included in all claims deriving therefrom.

What is claimed is:

1. An infant safety cap comprising:
a cap receiving end having a receiving channel;
an outer edge of the cap forming a choke-prevention guard for the cap;
the cap configured to provide a clear view section around a small outer diameter fluid delivery channel of the cap;
the outer edge formed to at least one of directly or indirectly connect to the fluid delivery channel of the cap; and
the receiving channel constructed to selectively and removably connect to at least one of an ENFit syringe, a pharmaceutical bottle, and a container.

2. An ENFit syringe safety cap system comprising:
an ENFit syringe; and
an infant safety cap as claimed in claim 1, the infant safety cap configured to selectively connect to the ENFit syringe.

3. The infant safety cap of claim 1, further comprising a removable cap seal, the removable cap seal connectable to form a tamper-resistant seal connecting an outlet of the small outer diameter fluid delivery channel to at least one of the outer edge, the ENFit syringe, the pharmaceutical bottle, and the container.
